(19) United States
(12) Patent Application Publication
(10) Pub. No.: US 2020/0190418 A1
(43) Pub. Date: Jun. 18, 2020

(54) OIL, METHOD AND APPARATUS

(71) Applicants: HERIOT-WATT UNIVERSITY, Edinburgh (GB); HARRIS TWEED AUTHORITY, Stornoway Isle Of Lewis (GB)

(72) Inventors: Aimaro Sanna, Edinburgh (GB); Roozbeh Kalateh, Aberdeen (GB); Dan Mei Sun, Galashiels (GB)

(21) Appl. No.: 16/644,317

(22) PCT Filed: Sep. 4, 2018
(86) PCT No.: PCT/GB2018/052494

§ 371 Date: Mar. 4, 2020

(30) Foreign Application Priority Data
Sep. 4, 2017 (GB) 1714113.6
Mar. 16, 2018 (GB) 1804209.3

(51) Int. Cl. C10L 1/00; C10J 3/20; C10J 3/06; C10J 3/84; C10J 3/00; B65G 33/08; B65G 47/18; C10B 53/07; C10B 31/04; C10B 7/10

(52) U.S. Cl. CPC C10L 1/00; C10L 2290/28; C10J 3/06; C10J 3/84; C10J 3/007; B65G 33/08; B65G 47/18; C10B 53/07; C10B 31/04; C10B 7/10; C10L 2290/02; C10J 2200/158; C10J 2300/0906; C10J 2300/0946; C10J 2300/1621; C10L 2200/0469; C10L 2290/04; C10J 3/20

(57) ABSTRACT

A thermolysis oil derived from textile is described. The oil comprises an N-heterocyclic aromatic compound and/or a substituted derivative thereof in an amount of at least 2 wt. %. Also described is a method of providing a thermolysis oil, a feeder (100) for an apparatus (1) for thermolysing a textile, an apparatus (1) for thermolysing a textile and a use of waste textile.

### FIELD

The present invention relates to a thermolysis oil derived from textile, a method of providing a thermolysis oil, a feeder for an apparatus for thermolysing a textile, an apparatus for thermolysing a textile and a use of waste textile.

### BACKGROUND TO THE INVENTION

Textile waste typically includes offcuts of woven and non-woven fibres, together with disposed garments, soft furnishings, carpets and coverings, and accounts for an increasing proportion of industrial and domestic waste. In the UK, an estimated 1 million tonnes of textile waste is disposed of in landfill annually while an order of magnitude more is similarly disposed of in the US. Textile waste disposed of in landfill may accelerate global warming by decomposing to produce greenhouse gases, including CH₄ and CO₂. Generally, textiles comprise fibres derived from four main sources: animal, for example wool and silk; plant, for example cotton, flax and jute; mineral, for example asbestos and glass fibre; and synthetic, for example nylon, polyester, acrylic. Textiles comprising fibres derived from animal and/or plant sources (i.e. biomass) may be particularly problematic with respect to greenhouse gas production during landfill decomposition. Furthermore, textiles may comprise additives, for example dyes, coatings and/or modifiers, that may leach during landfill and/or contaminate the environment.

Hence, there is a need to improve disposal of textiles, particularly textiles comprising fibres derived from animal and/or plant sources and/or textiles comprising additives.

### SUMMARY OF THE INVENTION

It is one aim of the present invention, amongst others, to provide which at least partially obviates or mitigates at least some of the disadvantages of the prior art, whether identified herein or elsewhere. For instance, it is an aim of embodiments of the invention to obtain a product from textile that may be otherwise disposed by landfill. For instance, it is an aim of embodiments of the invention to provide method to obtain a product from textile that may be otherwise disposed by landfill. For instance, it is an aim of embodiments of the invention to provide an apparatus for obtain a product from textile that may be otherwise disposed by landfill. For instance, it is an aim of embodiments of the invention to provide a use of waste textile that may be otherwise disposed by landfill.

According to the first aspect, there is provided a thermolysis oil derived from textile, the oil comprising an N-heterocyclic aromatic compound and/or a substituted derivative thereof in an amount of at least 2 wt. %.

According to a second aspect, there is provided a method of providing a thermolysis oil comprising an N-heterocyclic aromatic compound, a phenol and/or a substituted derivative thereof, the method comprising:

thermolysing a textile comprising keratin, to provide vapours from the textile;

condensing the vapours to obtain the oil.

According to a third aspect, there is provided a feeder for feeding textile into a thermal reactor for thermolysing the textile;

wherein the feeder comprises a hopper arranged to receive the textile, a feeder outlet coupleable to the thermal reactor and a screw conveyor arranged therebetween, wherein the screw conveyor is arranged to, in use, urge at least a part of the textile from the hopper towards the feeder outlet; and

wherein the feeder further comprises a loosening means arranged in the hopper, wherein the loosening means is arranged to, in use, loosen at least the part of the textile and thereby urge at least the part of the textile from the hopper towards the screw conveyor.

According to a fourth aspect, there is provided an apparatus for thermolysing a textile, the apparatus comprising a feeder according to the third aspect and a thermal reactor.

According to a fifth aspect, there is provided use of waste textile comprising keratin as a feedstock for obtaining oil by pyrolysis or gasification.

### DETAILED DESCRIPTION OF THE INVENTION

According to the present invention there is provided, as set forth in the appended claims. Also provided is. Other features of the invention will be apparent from the dependent claims, and the description that follows.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

According to the first aspect, there is provided a thermolysis oil derived from textile, the oil comprising an N-heterocyclic aromatic compound and/or a substituted derivative thereof in an amount of at least 2 wt. %.

Generally, thermolysis (also known as thermal decomposition) is chemical decomposition of matter caused by heat. Thermolysis processes include torrefecation, pyrolysis, gasification and combustion, classified according to temperature, oxygen presence and residence time (or thermolysis time), as shown in Table 1. Of particular interest are pyrolysis and gasification.

TABLE 1
Thermolysis processes.

| Methods | Temperature (° C.) | Oxygen | Residence time (s) |
|---|---|---|---|
| Torrefaction | 200-400 | No | >300 |
| Slow pyrolysis | 400 | No | >86400 |
| Intermediate | 500 | No | 10-30 |
| pyrolysis | | | |
| Fast pyrolysis | 500 | No | 1 |
| Gasification | 750-900 | Yes | variable |
| Combustion | >1500 | Yes | — |

Generally, pyrolysis of biomass is the thermal decomposition of the biomass at a temperature of about 500° C. in an absence of oxygen and may results in three different products: gas (biogas or syngas), liquid (bio oil or biocrude) and solid (biochar). Pyrolysis of biomass may be described by simplified equation 1:

(C₆H₁₂O₆)ₘ→(H₂+CO+CH₄+ . . . +C₅H₁₂)+(H₂O+ . . . +CH₃OH+CH₃COOH+ . . . )+C Equation 1

Distributions (for example, proportions) and/or compositions of the gas, liquid and solid products may be dependent on several factors such as thermal reactor type, temperature, heating rate, feedstock (biomass) composition and/or thermal reactor pressure. Table 2 shows typical pyrolysis product distributions for fast, intermediate and slow pyrolysis.

TABLE 2
Typical pyrolysis product distributions.

| | Product Distribution (%) | | |
|---|---|---|---|
| Mode | Gas | Liquid | Solid |
| Fast pyrolysis | 13 | 75 | 12 |
| Intermediate pyrolysis | 25 | 50 | 25 |
| Slow pyrolysis | 35 | 30 | 35 |

A composition of the pyrolysis biogas may depend on the feedstock and/or process conditions and typically mainly comprises carbon monoxide, carbon dioxide, hydrogen and light hydrocarbons, for example CH₄ and C₂H₆. Combustion of the biogas may be used to provide heat for the pyrolysis.

The pyrolysis bio oil may account for about 30% to about 75% of the pyrolysis products. Table 3 shows typical components of bio oil derived from (for example, obtained by) pyrolysis of lignocellulosic biomass (for example, wood) compared with components determined for bio oil derived from (for example, obtained by) pyrolysis of wool textile.

TABLE 3
Components of bio oils derived from lignocellulosic
biomass and wool textile.

| | Principal Compounds | Principal Compounds |
|---|---|---|
| Organic Groups | (Lignocellulosic) | (Wool) |
| Acids | Formic, Acetic acid | Pentanoic acid |
| Alcohols | Methanol, Ethanol | NA |
| Esters | Methyl formate, Propionate | NA |
| Ketones | Acetone, 2-Butanone | NA |
| Aldehydes | Formaldehyde, Acetaldehyde | NA |
| Phenols | Phenol, methyl substituted | Phenol, substituted |
| | phenols | phenols |
| Aromatics | Benzene, Toulene, Xylenes, | Benzene substitutes |
| | Naphtalenes | |
| Guaiacols | Methoxy-phenol, 4-methyl- | NA |
| | guaiacol, ethyl-guaiacol | |
| Sugars | Levoglucosan, Glucose, | NA |
| | Fructose, D-arabinose | |
| Furans | Furan, 2-Methyl furan, | NA |
| | Furfural, Furfural alcohol | |
| N-compounds | NA | Piperidinones, |
| | | Pirazines, Pirroles |

Components such as carboxylic acid, phenols, aldehydes and ketones may be undesirable in bio oils for use as fuels. However, phenols may be industrially valuable as feedstocks or raw materials for other industrial processes. From Table 3, the bio oil derived from wool textile comprises fewer components and fewer undesirable components than the bio oil derived from lignocellulosic biomass and thus the bio oil derived from wool textile is industrially useful, for use as a fuel and/or a source of valuable chemicals.

The pyrolysis biochar typically comprises at least 50 wt. % C and is industrially useful, for use in soil amendment and carbon capture and sequestration.

Generally, gasification of the biomass is the thermal decomposition of the biomass at a temperature of from about 700° C. to about 1000° C. in a presence of a limited amount of oxygen and may also result in the three different products: gas (biogas or syngas), liquid (bio oil or biocrude) and solid (biochar). In contrast with pyrolysis, the gas product is the main product of gasification.

The gasification biogas typically comprises hydrogen, carbon monoxide, carbon dioxide and methane, in contrast with the pyrolysis biogas.

The gasification bio oil is typically a biotar.

The gasification biochar is similar to that derived by pyrolysis, but is expected to have a C content >60%.

In one example, the thermolysis oil comprises a pyrolysis oil and/or a gasification oil. In one example, the thermolysis oil is a pyrolysis oil or a gasification oil or a mixture thereof. In one example, the thermolysis oil is a pyrolysis oil. In one example, the thermolysis oil is a gasification oil.

The thermolysis oil comprises the N-heterocyclic aromatic compound and/or the substituted derivative thereof in an amount of at least 2 wt. %. It should be understood that the amount of the N-heterocyclic aromatic compound and/or the substituted derivative thereof is by weight or mass percent of the thermolysis oil.

N-heterocyclic aromatic compounds are heterocyclic aromatic compounds having N included in the aromatic ring.

In one example, the N-heterocyclic aromatic compound is pyrrole, pyridine, imidazole, pyrimidine, purine, piperidinone, pyrazine, quinoline or indole.

In one example, the thermolysis oil comprises more than one of these N-heterocyclic aromatic compounds, for example a mixture of pyrrole, pyridine, imidazole, pyrimidine, purine, piperidinone, pyrazine, quinoline, indole and/or a substituted derivative thereof in an amount of at least 2 wt. %.

In one example, the thermolysis oil comprises the N-heterocyclic aromatic compound and/or the substituted derivative thereof in an amount of at least 2 wt. %, wherein the N-heterocyclic aromatic compound is indole, quinoline, pyrrole, piperidinone, pyrazine or a mixture thereof.

In one example, the thermolysis oil comprises the N-heterocyclic aromatic compound and/or the substituted derivative thereof in an amount of at least 2 wt. %, wherein the N-heterocyclic aromatic compounds are indole and/or quinoline.

Indole is an aromatic heterocyclic organic compound having a formula C₈H₇N. Indole has a bicyclic structure, consisting of a six-membered benzene ring fused to a five-membered nitrogen-containing pyrrole ring (Structure 1).

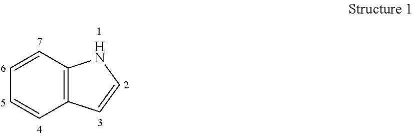

Piperidinone is a derivative of piperidine with the molecular formula C₅H₉NO. It is used as an intermediate in the manufacture of chemicals and pharmaceuticals.

Quinoline is an aromatic organic compound, and it has a heterocyclic structure (Structure 2). Quinoline is used in the manufacture of dyes, the preparation of hydroxyquinoline sulfate and niacin. It is also used as a solvent for resins and terpenes. Quinoline is mainly used as in the production of other specialty chemicals. Quinoline derivatives are probably best known for their diverse pharmacological properties, however they have also been successfully applied as optical switches in nonlinear optics, sensors in electrochemistry and in the field of inorganic chemistry. Less than 5 tonne were produced annually in 2005 (Collin and Hoke, 2005). Currently, quinoline has a market value between $20,000 and $100,000/t, depending on purity.

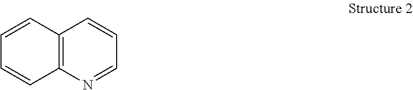

In one example, the thermolysis oil comprises the N-heterocyclic aromatic compound and/or the substituted derivative thereof in an amount of at least 2 wt. %, at least 3 wt. %, at least 4 wt. %, at least 5 wt. %, at least 6 wt. %, at least 7 wt. %, at least 8 wt. %, at least 9 wt. %, at least 10 wt. %, at least 11 wt. %, at least 12 wt. %, at least 13 wt. %, at least 14 wt. %, at least 15 wt. %, at least 16 wt. %, at least 17 wt. %, at least 18 wt. %, at least 19 wt. % or at least 20 wt. %. 2 to 30, etc

In one example, the thermolysis oil comprises the N-heterocyclic aromatic compound and/or the substituted derivative thereof in an amount of at 4 wt. %, at most 5 wt. %, at most 6 wt. %, at most 7 wt. %, at most 8 wt. %, at most 9 wt. %, at most 10 wt. %, at most 11 wt. %, at most 12 wt. %, at most 13 wt. %, at most 14 wt. %, at most 15 wt. %, at most 16 wt. %, at most 17 wt. %, at most 18 wt. %, at most 19 wt. %, at most 20 wt. %, at most 25 wt. %, at most 30 wt. %, at most 40 wt. % or at most 50 wt. %.

In one example, the oil comprises phenol and/or a substituted derivative thereof in an amount of at least 10 wt. %. It should be understood that the amount of the phenol and/or the substituted derivative thereof is by weight or mass percent of the thermolysis oil.

In one example, the thermolysis oil comprises the phenol and/or the substituted derivative thereof in an amount of at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %.

In one example, the thermolysis oil comprises the phenol and/or the substituted derivative thereof in an amount of at most 20 wt. %, at most 25 wt. %, at most 30 wt. %, at most 35 wt. %, at most 40 wt. %, at most 45 wt. %, at most 50 wt. %, at most 55 wt. %, at most 60 wt. %, at most 65 wt. %, at most 70 wt. %, at most 75 wt. % or at most 80 wt. %.

According to the second aspect, there is provided a method of providing a thermolysis oil comprising an N-heterocyclic aromatic compound, a phenol and/or a substituted derivative thereof, the method comprising:

thermolysing a textile comprising keratin, to provide vapours from the textile;

condensing the vapours to obtain the oil.

The thermolysis oil may be as described herein.

In one example, the textile comprises keratin in an amount of at least 20 wt. %.

Keratin is one of a family of fibrous structural proteins. α-keratins occur, for example, in hair (including wool), stratum corneum, horns, nails, claws and hooves of mammals and hagfish slime threads. β-keratins occur, for example, in nails of animals, in scales and claws of reptiles, and in shells of animals.

In one example, the textile comprises α-keratin in an amount of at least 20 wt. %.

In one example, the textile comprises the keratin and/or α-keratin in an amount of at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. % or at least 80 wt. %.

In one example, the textile comprises the keratin and/or α-keratin in an amount of at most 30 wt. %, at most 35 wt. %, at most 40 wt. %, at most 45 wt. %, at most 50 wt. %, at most 55 wt. %, at most 60 wt. %, at most 65 wt. %, at most 70 wt. %, at most 75 wt. % or at most 80 wt. %.

In one example, the textile comprises wool in an amount of at least 30 wt. %, the wool comprising at least a part of the keratin. It should be understood that the amount of the wool is by weight or mass percent of the textile.

Wool is a natural fibre comprising mainly of keratin, particularly α-keratin. Table 4 compares elemental compositions of keratin (as generalised wool composition) and a sample of industrial textile wool waste. Elemental composition (C, H, N) was determined using an Exeter CE-440 Elemental analyser, in accordance with the manufacturer's instructions.

TABLE 4
Elemental compositions of keratin and a
sample of industrial textile wool waste.

| wt. % | C | H | O | N | S |
|---|---|---|---|---|---|
| Keratin | 50 | 12 | 10 | 25 | 3 |
| Textile waste | 49.5 | 7.2 | 27.5 | 15.7 | NA |

The industrial textile wool waste presents C and H contents similar to those of lignocellulosic materials, while the large N content (˜16%) is due to high protein content in the wool waste. Larger content of 0 is linked to the presence of fatty acids and dyes, which contain oxygenated compounds. From a bio-char utilisation perspective, the presence of 12-15% N may make the material useful as an excellent soil amendment material, for instance compared with lignocellulosic bio-chars. The high N content of bio-char generated from industrial textile wool waste may be detrimental to its use as fuel due to potential NOₓ emissions. The N in biogas from wool (typically present as NH₃) may be removed from the biogas by scrubbing and may be used, for example, for growing microalgae or fertiliser production.

Since wool is composed mainly of protein, to ascertain which products are expected from its thermal decomposition, its constituent amino acids should be considered. Table 5 shows the amino acids of two different wool samples and the average composition. Glutamic acid, serine, cysteic acid and glycine are the most abundant amino acids.

TABLE 5
Amino acids in wool samples (P. R. J. Lancashire (2015) ‘Unit- chemistry
of Garments: Animal Fibres,’ Chemistry of Fibres, Textiles and
Garments, February 2015, http://wwwchem.uwimona.edu.im/courses/
CHEM2402/Textiles/Animal Fibres.html; J H Bradbury, G V Chapman
and N L R King (1965) ‘The Chemical Composition of Wool II.
Analysis of the Major Histological Components Produced by
Ultrasonic Disintegration’ Australian Journal of
Biological Sciences 18(2) 353-364.

| | Sample 1 | Sample 2 | Average |
|---|---|---|---|
| Amino acid | (μmol/g) | (μmol/g) | (μmol/g) |
| Cysteic acid | 1000 | 700 | 850 |
| Aspartic acid | 500 | 560 | 530 |
| Threonine | 550 | 572 | 561 |
| Serine | 920 | 902 | 911 |
| Glutamic acid | 980 | 1049 | 1014.5 |
| Proline | 590 | 522 | 556 |
| Glycine | 700 | 757 | 728.5 |
| Alanine | 460 | 469 | 464.5 |
| Valine | 460 | 486 | 473 |
| Methionine | 39 | 44 | 41.5 |
| Leucine | 630 | 676 | 653 |
| Tyrosine | 290 | 349 | 319.5 |
| Phenylalanine | 230 | 257 | 243.5 |
| Lysine | 220 | 269 | 244.5 |
| Histidine | 66 | 82 | 74 |
| Arginine | 550 | 600 | 575 |

In addition to protein, the wool may also comprise cellulose and/or fatty acids. The cellulose is formed in bundles of fibres attached together strongly and may be composed of D-glucose polymers.

In one example, the textile comprises the wool in an amount of at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. % or at least 80 wt. %.

In one example, the textile comprises the wool in an amount of at most 40 wt. %, at most 45 wt. %, at most 50 wt. %, at most 55 wt. %, at most 60 wt. %, at most 65 wt. %, at most 70 wt. %, at most 75 wt. %, at most 80 wt. %, at most 90 wt. % or at most 100 wt. %.

In one example, the wool comprises the keratin in an amount of at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. % or at least 80 wt. %.

In one example, the wool comprises the keratin in an amount of at most 30 wt. %, at most 35 wt. %, at most 40 wt. %, at most 45 wt. %, at most 50 wt. %, at most 55 wt. %, at most 60 wt. %, at most 65 wt. %, at most 70 wt. %, at most 75 wt. % or at most 80 wt. %.

In one example, the thermolysing comprises pyrolysing at a temperature of from about 350° C. to about 900° C., preferably from about 400° C. to about 750° C., more preferably from about 475° C. to about 600° C., for example 500° C.

In one example, the thermolysing comprises gasification at a temperature of from about 750° C. to about 1000° C., preferably from about 800° C. to about 900° C.

An amount of the N-heterocyclic aromatic compound, the phenol and/or the substituted derivative thereof may be dependent on thermolysing temperature, such that increased amounts of the N-heterocyclic aromatic compound, the phenol and/or the substituted derivative thereof are derived from (obtained by) thermolysing at higher temperatures.

In one example, the thermolysing comprises thermolysing at a N₂ pressure of from about 0.1 to about 1 MPa and/or at a CO₂ partial pressure of from about 0.05 to about 0.2 MPa and/or wherein the thermolysing comprises pyrolysing at an O₂ partial pressure of at most 0.025 MPa and/or wherein the thermolysing comprises gasification at an O₂ equivalent ratio (ER) of from about 0.2 to about 0.35, more preferably about 0.25.

Generally, thermolysing for example pyrolysing and/or gasification is performed under N₂ in order to avoid partial combustion reactions.

In one example, the thermolysing comprises thermolysing at a N₂ pressure of at least 0.01 MPa, at least 0.05 MPa, at least 0.1 MPa, at least 0.2 MPa, at least 0.3 MPa, at least 0.4 MPa, at least 0.5 MPa. Preferably, the thermolysing comprises thermolysing at a N₂ pressure of at least 0.1 MPa.

In one example, the thermolysing comprises thermolysing at a N₂ pressure of at most 0.6 MPa, at most 0.7 MPa, at most 0.8 MPa, at most 0.9 MPa, at most 1 MPa. Preferably, the thermolysing comprises thermolysing at a N₂ pressure of at most 0.8 MPa.

In one example, the thermolysing comprises thermolysing at a CO₂ partial pressure of at least 0.05 MPa, at least 0.1 MPa, at least 0.2 MPa, at least 0.3 MPa, at least 0.4 MPa, at least 0.5 MPa, at least 0.6 MPa, at least 0.7 MPa, at least 0.8 MPa, at least 0.9 MPa, at least 1 MPa. Preferably, the thermolysing comprises thermolysing at a CO₂ partial pressure of at least 0.1 MPa.

In one example, the thermolysing comprises thermolysing at a CO₂ partial pressure of at most at most 0.2 MPa, at most 0.3 MPa, at most 0.4 MPa, at most 0.5 MPa, at most 0.6 MPa, at most 0.7 MPa, at most 0.8 MPa, at most 0.9 MPa, at most 1 MPa. Preferably, the thermolysing comprises thermolysing at a CO₂ partial pressure of is at most 0.8 MPa.

Generally, pyrolysing may be in an absence of oxygen. In practice, small amounts of oxygen may be admitted, for example initially admitted to a pyrolysis thermal reactor together with the feedstock.

In one example, the thermolysing comprises pyrolysing at an O₂ partial pressure of at least 0.025 MPa, at least 0.03 MPa, at least 0.04 MPa, at least 0.05 MPa, at least 0.06 MPa, at least 0.07 MPa, at least 0.08 MPa, at least 0.09 MPa, at least 0.1 MPa or at least 0.2 MPa. Preferably, the thermolysing comprises pyrolysing at an O₂ partial pressure of at least 0.025 MPa.

In one example, the thermolysing comprises pyrolysing at an O₂ partial pressure of at most 0.04 MPa, at most 0.05 MPa, at most 0.06 MPa, at most 0.07 MPa, at most 0.08 MPa, at most 0.09 MPa, at most 0.1 MPa or at most 0.2 MPa. Preferably, the thermolysing comprises pyrolysing at an O₂ partial pressure of at most 0.04 MPa.

Generally, gasification may be in a presence of a limited amount of oxygen. For example, an amount of oxygen admitted to a gasification thermal reactor may be controlled during gasification.

The O₂ equivalent ratio (ER) may relate to an air: fuel ratio, for example for 1.6 kg air: 1 kg textile.

Optimum conventional gasification occurs at ˜0.25 equivalence ratio air (or oxygen) at temperatures close to 1000° C. and produces a gas whose active ingredients are CO and H2 with as little free carbon as possible. For rations >0.25, the reactions becomes exothermic.

In one example, the thermolysing comprises gasification at an O₂ equivalent ratio (ER) of at least 0.20, at least 0.25, at least 0.30. Preferably, the thermolysing comprises gasification at an O₂ equivalent ratio (ER) of at least 0.20, for example about 0.25.

In one example, the thermolysing comprises gasification at an O₂ equivalent ratio (ER) of at most 0.25, at most 0.30, at most 0.35. Preferably, the thermolysing comprises gasification at an O₂ equivalent ratio (ER) of at most 0.30, for example about 0.25.

In one example, the method comprises shredding the textile and thermolysing the shredded textile. Shredding the textile reduces a size of the textile, thereby facilitating handling and/or improving thermolysing, for example. Shredding the textile may normalize a size distribution of the textile, for example by providing textile pieces of more uniform size, thereby improving thermolysing, for example.

In one example, shredding the textile comprises cutting the textile, for example by mechanically cutting the textile. In one example, shredding the textile comprises grinding the textile, for example by mechanically grinding the textile.

In one example, the method comprises shredding the textile, wherein at least 50% of the shredded textile by weight has a size of at most 0.5 cm, at most 1.0 cm, at most 1.5 cm, at most 2.0 cm, at most 2.5 cm, at most 3.0 cm, at most 3.5 cm, at most 4.0 cm, at most 4.5 cm, at most 5.0 cm, at most 7.5 cm or at most 10 cm. Preferably, the method comprises shredding the textile, wherein at least 50% of the shredded textile by weight has a size of at most 1.5 cm.

In one example, the method comprises shredding the textile, wherein at least 50% of the shredded textile by weight has a size of at least 0.5 cm, at least 1.0 cm, at least 1.5 cm, at least 2.0 cm, at least 2.5 cm, at least 3.0 cm, at least 3.5 cm, at least 4.0 cm, at least 4.5 cm, at least 5.0 cm, at least 7.5 cm or at least 10 cm. Preferably, the method comprises shredding the textile, wherein at least 50% of the shredded textile by weight has a size of at least 0.5 cm.

In one example, the method comprises shredding the textile, wherein at least 90% of the shredded textile by weight has a size of at most 0.5 cm, at most 1.0 cm, at most 1.5 cm, at most 2.0 cm, at most 2.5 cm, at most 3.0 cm, at most 3.5 cm, at most 4.0 cm, at most 4.5 cm, at most 5.0 cm, at most 7.5 cm or at most 10 cm. Preferably, the method comprises shredding the textile, wherein at least 90% of the shredded textile by weight has a size of at most 2.5 cm.

In one example, the method comprises shredding the textile, wherein at least 90% of the shredded textile by weight has a size of at least 0.5 cm, at least 1.0 cm, at least 1.5 cm, at least 2.0 cm, at least 2.5 cm, at least 3.0 cm, at least 3.5 cm, at least 4.0 cm, at least 4.5 cm, at least 5.0 cm, at least 7.5 cm or at least 10 cm. Preferably, the method comprises shredding the textile, wherein at least 90% of the shredded textile by weight has a size of at least 0.5 cm

In one example, the method comprises shredding the textile, wherein at least 95% of the shredded textile by weight has a size of at most 0.5 cm, at most 1.0 cm, at most 1.5 cm, at most 2.0 cm, at most 2.5 cm, at most 3.0 cm, at most 3.5 cm, at most 4.0 cm, at most 4.5 cm, at most 5.0 cm, at most 7.5 cm or at most 10 cm. Preferably, the method comprises shredding the textile, wherein at least 95% of the shredded textile by weight has a size of at most 2.5 cm.

In one example, the method comprises shredding the textile, wherein at least 95% of the shredded textile by weight has a size of at least 0.5 cm, at least 1.0 cm, at least 1.5 cm, at least 2.0 cm, at least 2.5 cm, at least 3.0 cm, at least 3.5 cm, at least 4.0 cm, at least 4.5 cm, at least 5.0 cm, at least 7.5 cm or at least 10 cm. Preferably, the method comprises shredding the textile, wherein at least 95% of the shredded textile by weight has a size of at least 0.5 cm.

In one example, the textile comprises waste textile. In one example, the textile is waste textile.

In one example, the textile comprises waste textile in an amount of at least 0.5 wt. %, at least 1 wt. %, at least 2 wt. %, at least 5 wt. %, at least 10 wt. %, at least 15 wt. %, at least 20 wt. %, at least 25 wt. %, at least 30 wt. %, at least 35 wt. %, at least 40 wt. %, at least 45 wt. %, at least 50 wt. %, at least 55 wt. %, at least 60 wt. %, at least 65 wt. %, at least 70 wt. %, at least 75 wt. %, at least 80 wt. %, at least 85 wt. %, at least 90 wt. % or at least 95 wt. Preferably the textile comprises waste textile in an amount of at least 20 wt. %. More preferably the textile comprises waste textile in an amount of at least 50 wt. %.

In one example, the textile comprises waste textile in an amount of at most 0.5 wt. %, at most 1 wt. %, at most 2 wt. %, at most 5 wt. %, at most 10 wt. %, at most 15 wt. %, at most 20 wt. %, at most 25 wt. %, at most 30 wt. %, at most 35 wt. %, at most 40 wt. %, at most 45 wt. %, at most 50 wt. %, at most 55 wt. %, at most 60 wt. %, at most 65 wt. %, at most 70 wt. %, at most 75 wt. %, at most 80 wt. %, at most 85 wt. %, at most 90 wt. %, at most 95 wt. % or at most 100 wt. Preferably the textile comprises waste textile in an amount of at most 100 wt. %.

In one example, the method comprises separating the N-heterocyclic aromatic compound, the phenol and/or the substituted derivative thereof from the oil.

According to the third aspect, there is provided a feeder for feeding textile into a thermal reactor for thermolysing the textile;

wherein the feeder comprises a hopper arranged to receive the textile, a feeder outlet coupleable to the thermal reactor and a screw conveyor arranged therebetween, wherein the screw conveyor is arranged to, in use, urge at least a part of the textile from the hopper towards the feeder outlet; and wherein the feeder further comprises a loosening means arranged between the hopper and the screw conveyor, wherein the loosening means is arranged to, in use, loosen at least the part of the textile and thereby urge at least the part of the textile from the hopper towards the screw conveyor.

In contrast to conventional biomass (for example wood chip) textile, particularly pieces thereof for example shredded pieces thereof, tends to entangle, compact, mat, clump or wad in the hopper, for example as a result of fibre entanglement. This entanglement of the textile in the hopper may result in blockages therein and/or downstream, such that an amount of the textile received by and/or urged by the screw conveyor is reduced and/or prevented. In some cases, entanglement of the textile in the hopper may result in no textile being urged by the screw conveyor, in use.

The hopper may have a cuboidal, pyramidal, truncated pyramidal, cylindrical, conical and/or frustoconical shape, for example. The loosening means is arranged in the hopper, typically adjacent to the screw conveyor. The loosening means is arranged to, in use, loosen at least the part of the textile and thereby urge at least the part of the textile from the hopper towards the screw conveyor. In other words, the loosening means functions to loosen or disentangle the textile that tends to entangle, compact, mat, clump or wad in the hopper. The loosened or disentangled textile is then urged by the screw conveyor towards the feeder outlet and hence into the thermal reactor. In this way, blockages are reduced and/or the amount of the textile received by and/or urged by the screw conveyor is increased.

The textile may be as described herein.

The feeder may be provided for and/or with a new apparatus. Additionally and/or alternatively, the feeder may be provided for an existing thermal reactor, for example as a replacement for a conventional feeder. The loosening means may be provided with and/or for a new feeder. Additionally and/or alternatively, the loosening means may be provided for an existing conventional feeder, for example as an upgrade for the conventional feeder.

In one example, the loosening means comprises a rotatable arm, arranged to rotate in use. In one example, the loosening means comprises a plurality of rotatable arms, arranged to rotate in use. In one example, the plurality of rotatable arms are mutually rotatationally offset. In this way, a force on the arms may be reduced. Additionally and/or alternatively, urging of the part of the textile from the hopper towards the screw conveyor by the loosening means may be improved, for example, may be more uniform. In one example, the arm comprises a paddle or a blade.

In one example, a rotational axis of the rotatable arm is aligned with and/or parallel to a rotational axis of the screw conveyor. In one example, a rotational axis of the rotatable arm is transverse to and/or orthogonal to a rotational axis of the screw conveyor. In one example, the rotatable arm is arranged to rotate in a direction of rotation and the screw conveyor is arranged to rotate in the same direction of rotation. In one example, the rotatable arm is arranged to rotate in a direction of rotation and the screw conveyor is arranged rotate to in an opposed (or counter) direction of rotation. In one example, the rotatable arm is arranged to rotate at a speed of rotation and the screw conveyor is arranged to rotate at the same speed of rotation. In one example, the rotatable arm is arranged to rotate at a speed of rotation and the screw conveyor is arranged to rotate at a different speed of rotation, for example a lesser or a greater speed of rotation. In one example, rotation of the rotatable arm is independent of rotation of the screw conveyor. In one example, rotation of the rotatable arm is dependent upon rotation of the screw conveyor, for example rotation of the rotatable arm and rotation of the screw conveyor may be synchronised. In one example, the rotatable arm is arranged to rotate at a speed of rotation in a range from 1 rpm to 10 rpm. In one example, a speed of rotation of the rotatable arm is controllable, for example by a controller.

In one example, the hopper is a gravity hopper.

In one example, the screw conveyor is arranged in the hopper, for example, proximal a base of the hopper. In one example, the loosening means is arranged in the hopper, for example, spaced apart from the screw conveyor and/or relatively less proximal the base of the hopper.

In one example, the feeder comprises a screw conveyor housing, wherein the screw conveyor is arranged in the screw conveyor housing and wherein the screw conveyor housing comprises a screw conveyor housing inlet and the feeder outlet. In one example, the screw conveyor housing comprises a tubular housing. In one example, the hopper comprises a hopper outlet. In one example, the hopper outlet is coupled to the screw conveyor housing inlet. In this way, the textile received in the hopper passes, in use, into the screw conveyor housing via the hopper outlet and the screw conveyor housing inlet. In one example, the loosening means is arranged proximal the hopper outlet. In one example, the loosening means is arranged in the hopper proximal the hopper outlet. In one example, the loosening means is arranged in the hopper in the hopper outlet. In one example, the loosening means is arranged proximal the screw conveyor housing inlet. In one example, the loosening means is arranged in the screw conveyor housing inlet. In one example, the loosening means is arranged in the screw conveyor housing. In one example, the loosening means is arranged in the screw conveyor housing proximal the screw conveyor housing inlet.

The screw conveyor is arranged to, in use, urge at least a part of the textile from the hopper towards the feeder outlet.

Generally, screw conveyors or auger conveyors are mechanisms for moving liquid or granular materials, that use rotating helical screw blades, also known as flightings, arranged around shafts and typically within housings or tubes. For reference purposes, an end of the screw conveyor proximal the feeder outlet may be referred to as the proximal end and the opposed end of the screw conveyor may be referred to as the distal end.

In one example, the screw conveyor is arranged to extend through the feeder outlet. For example, the screw conveyor may be arranged to extend through the feeder outlet and away therefrom, for example into the thermal reactor.

In one example, a shaft diameter of the screw conveyor decreases along a length of the screw conveyor towards the feeder outlet. In other words, the shaft diameter of the screw conveyor at the proximal end may be less than the shaft diameter of the screw conveyor at the distal end. In one example, the shaft diameter of the screw conveyor tapers towards the feeder outlet. In one example, the shaft diameter decreases along a part of the length of the screw conveyor towards the feeder outlet, for example the part towards the distal end. The shaft diameter of a remaining part of the length of the screw conveyor may be constant.

In this way, the screw conveyor advantageously aids movement of the textile from the feeder towards the feeder outlet, limiting undesired accumulation of the textile.

In one example, a flight outside diameter of the screw conveyor is constant, for example substantially constant, along a length of the screw conveyor towards the feeder outlet. In one example, a flight outside diameter of the screw conveyor decreases along a length of the screw conveyor towards the feeder outlet. In one example, a flight outside diameter of the screw conveyor increases along a length of the screw conveyor towards the feeder outlet.

In one example, a pitch of the screw conveyor increases along a length of the screw conveyor towards feeder outlet. In other words, the pitch of the screw conveyor at the proximal end may be greater than the pitch of the screw conveyor at the distal end. In one example, the pitch of the screw conveyor increases linearly towards the feeder outlet. In one example, the pitch of the screw conveyor increases non-linearly towards the feeder outlet. In one example, the pitch of the screw conveyor increases along a part of the length of the screw conveyor towards the feeder outlet, for example the part towards the distal end. The pitch of the screw conveyor of a remaining part of the length of the screw conveyor may be constant.

In this way, the screw conveyor advantageously aids movement of the textile from the feeder towards the feeder outlet, limiting undesired accumulation of the textile.

In one example, a pitch of the screw conveyor decreases along a length of the screw conveyor towards feeder outlet. In one example, a pitch of the screw conveyor is constant, for example substantially constant, along a length of the screw conveyor towards feeder outlet.

While the feeder according to the third aspect is suitable for feeding textile into a thermal reactor for thermolysing the textile, the feeder may be suitable for feeding textile into other textile processing devices.

According to the fourth aspect, there is provided an apparatus for thermolysing a textile, the apparatus comprising a feeder according to the third aspect and a thermal reactor.

Various types of thermal reactor for thermolysing biomass are known, for example fixed bed fast pyrolysis reactors, bubbling fluidized-bed reactors, circulating fluidized-bed reactors, rotating cone reactors, vacuum pyrolysis reactors, rotary kilns, screw (also known as auger) reactors, microwave pyrolysis reactors and hydro pyrolysis reactors.

In one example, the thermal reactor is a screw reactor and the screw conveyor of the feeder is coupled to a screw conveyor of the screw reactor.

In one example, the screw conveyor of the feeder and the screw conveyor of the screw reactor are integrally formed.

In one example, the thermal reactor includes a plurality of gas outlets. The plurality of gas outlets may aid removal of gases formed during the thermolysing. This arrangement of the plurality of gas outlets may reduce problems with gas flow into the thermal reactor. Additionally and/or alternatively, this arrangement of the plurality of gas outlets may reduce secondary reactions due to a long residence of the gases in the thermal reactor.

In one example, the apparatus comprises a collector, for example to collect biogas, bio oil and/or biochar.

According to the fifth aspect, there is provided use of waste textile comprising keratin as a feedstock for obtaining oil by pyrolysis or gasification.

The textile, the oil, the pyrolysis and/or the gasification may be as described herein.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 schematically depicts a feeder according to an exemplary embodiment;

FIGS. 2A and 2B schematically depict a feeder according to an exemplary embodiment;

FIG. 3 schematically depicts a conventional screw conveyor;

FIGS. 4A and 4B schematically depict a screw conveyor for a feeder according to an exemplary embodiment;

FIG. 5 schematically depicts an apparatus according to an exemplary embodiment;

FIG. 6 schematically depicts a thermal reactor of the apparatus of FIG. 5, in more detail;

FIG. 7 schematically depicts a method according to an exemplary embodiment;

FIG. 8 schematically depicts a graph showing thermolysis liquid product composition as a function of temperature in presence of CO₂ as carrier gas; and

FIG. 9 schematically depicts a graph showing thermolysis liquid product composition at 800° C. using different reactor sizes in presence of N₂ as carrier gas.

### DETAILED DESCRIPTION OF THE DRAWINGS

Generally, like reference signs denote like features, description of which is not repeated for brevity.

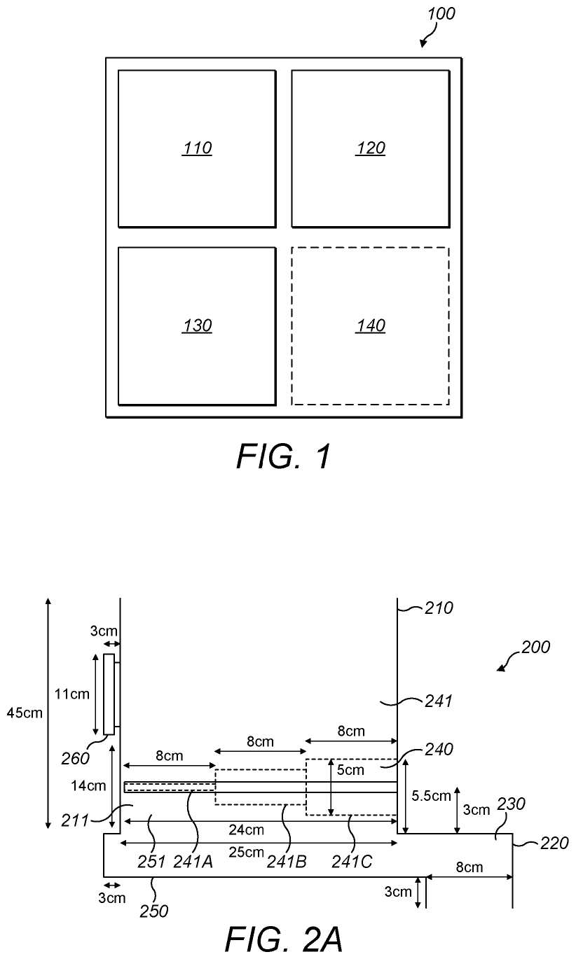

FIG. 1 schematically depicts a feeder 100 according to an exemplary embodiment.

Particularly, the feeder 100 is for an apparatus (not shown) for thermolysing a textile, the apparatus comprising the feeder 100 and a thermal reactor (not shown). The feeder 100 comprises a hopper 110 arranged to receive the textile, a feeder outlet 120 coupleable to the thermal reactor and a screw conveyor 130 arranged therebetween, wherein the screw conveyor 130 is arranged to, in use, urge at least a part of the textile from the hopper 110 towards the feeder outlet 120. The feeder 100 further comprises a loosening means 140 arranged between the hopper 110 and the screw conveyor 130, wherein the loosening means 140 is arranged to, in use, loosen at least the part of the textile and thereby urge at least the part of the textile from the hopper 110 towards the screw conveyor 130.

The loosening means 140 is arranged between the hopper 110 and the screw conveyor 130. The loosening means 140 is arranged to, in use, loosen at least the part of the textile and thereby urge at least the part of the textile from the hopper 110 towards the screw conveyor 130. In other words, the loosening means 140 functions to loosen or disentangle the textile that tends to entangle, compact, mat, clump or wad in the hopper 110. The loosened or disentangled textile is then urged by the screw conveyor 130 towards the feeder outlet 120 and hence into the thermal reactor. In this way, blockages are reduced and/or the amount of the textile received by and/or urged by the screw conveyor 110 is increased.

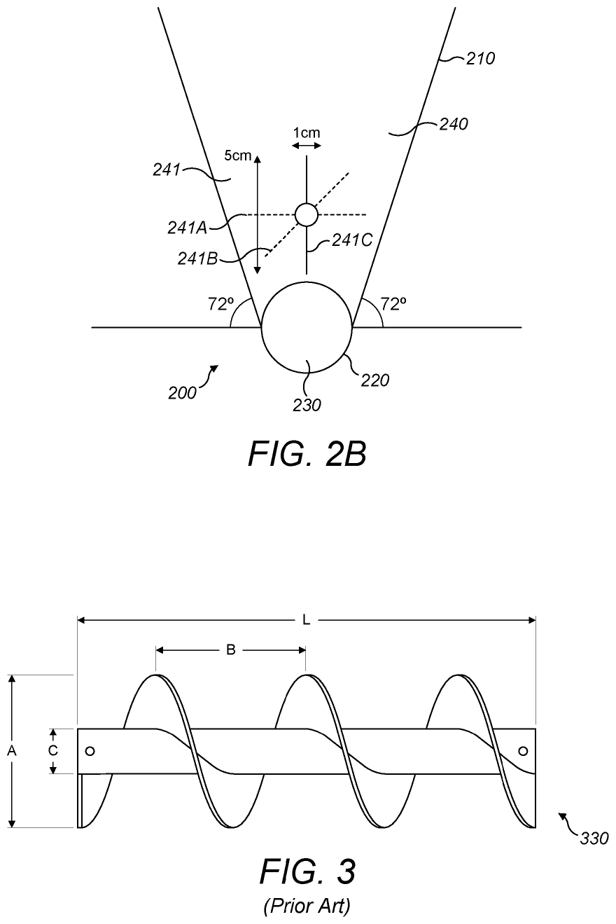

FIGS. 2A and 2B schematically depict a feeder 200 according to an exemplary embodiment.

Particularly, FIG. 2A schematically depicts a front cross-sectional view of the feeder 200 and FIG. 2B schematically depicts a side cross-sectional view of the feeder 200.

Particularly, the feeder 200 is for an apparatus (not shown) for thermolysing a textile, the apparatus comprising the feeder 200 and a thermal reactor (not shown). The feeder 200 comprises a hopper 210 arranged to receive the textile, a feeder outlet 220 coupleable to the thermal reactor and a screw conveyor 230 arranged therebetween, wherein the screw conveyor 230 is arranged to, in use, urge at least a part of the textile from the hopper 210 towards the feeder outlet 220. The feeder 200 further comprises a loosening means 240 arranged between the hopper 210 and the screw conveyor 230, wherein the loosening means 240 is arranged to, in use, loosen at least the part of the textile and thereby urge at least the part of the textile from the hopper 210 towards the screw conveyor 230.

In more detail, the hopper 210 is a gravity hopper, having a V cross-section, as shown in FIG. 2B. The loosening means 240 comprises a rotatable arm 241, arranged to rotate in use.

Particularly, the loosening means 240 comprises three (i.e. a plurality) of rotatable arms 241A-241C, arranged to rotate in use. The plurality of rotatable arms 241A-241C are mutually rotatationally offset by at least 45°. In this way, a force on the arms 241A-241C may be reduced. Additionally and/or alternatively, urging of the part of the textile from the hopper 210 towards the screw conveyor 230 by the loosening 240 means may be improved, for example, may be more uniform. The rotatable arms 241A-241C comprise a paddle or a blade, each having dimensions 8 cm×2.5 cm.

A rotational axis of the rotatable arm 241A-241C is aligned with and/or parallel to a rotational axis of the screw conveyor 230. Rotation of the rotatable arm 241A-241C is independent of rotation of the screw conveyor 230. The rotatable arm 241A-241C is arranged to rotate at a speed of rotation in a range from 1 rpm to 10 rpm. This speed of rotation is controllable, via a controller (not shown).

The feeder 200 comprises a screw conveyor housing 250, wherein the screw conveyor 230 is arranged in the screw conveyor housing 250 and wherein the screw conveyor housing 250 comprises a screw conveyor housing inlet 251 and the feeder outlet 220. The screw conveyor housing 250 comprises a tubular housing. The hopper 210 comprises a hopper outlet 211. The hopper outlet 211 is coupled to the screw conveyor housing inlet 251. The loosening means 240 is arranged in the hopper 210 proximal the hopper outlet 211. In this way, the textile received in the hopper 210 passes, in use, into the screw conveyor housing 250 via the hopper outlet 211 and the screw conveyor housing inlet 251.

FIG. 3 schematically depicts a conventional screw conveyor 330. Particularly, FIG. 3 schematically depicts a side elevation view of the conventional screw conveyor 330, having a length L, a flight outside diameter A, a pitch B and a shaft diameter C, for reference. The screw conveyor 330 is suitable for use in the feeder 200, for example.

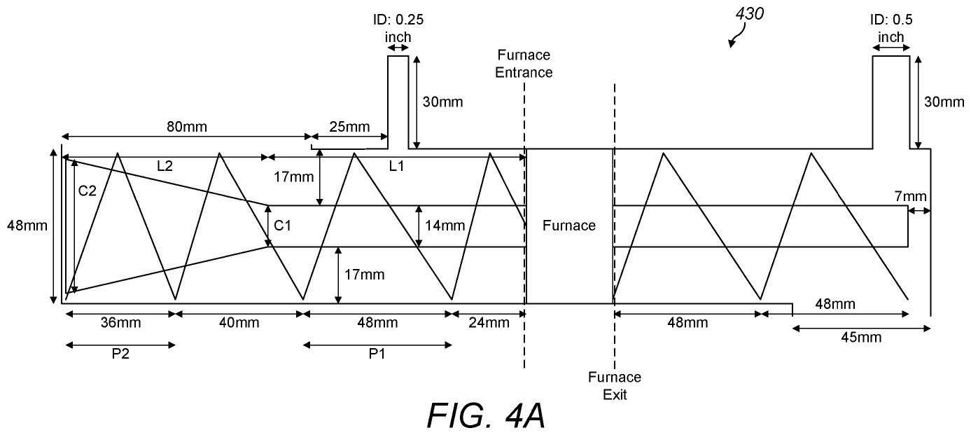

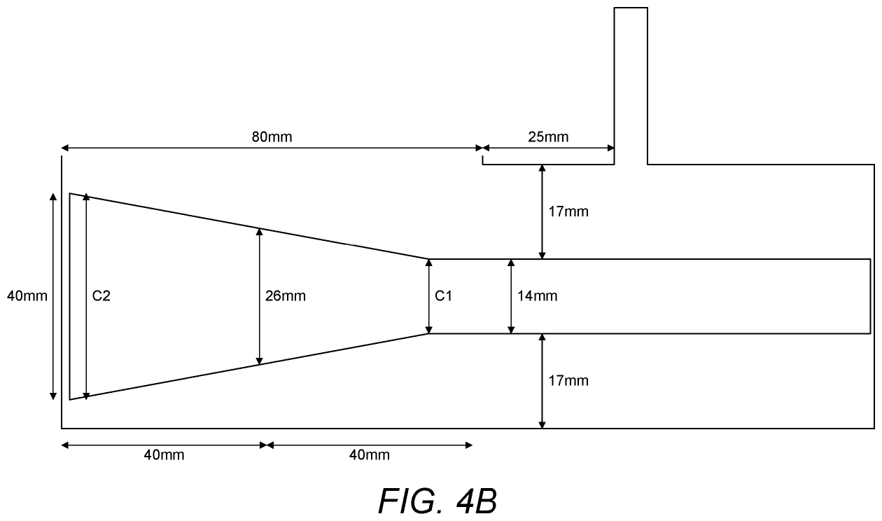

FIGS. 4A and 4B schematically depict a screw conveyor 430 for a feeder according to an exemplary embodiment. Particularly, FIG. 4A schematically depicts a side cross-sectional view of the screw conveyor 430 and FIG. 4B schematically depicts a side cross-sectional view of the shaft of the screw conveyor 430 in more detail. The screw conveyor 430 is suitable for use in the feeder 200, for example.

A shaft diameter C of the screw conveyor 430 decreases along a length of the screw conveyor 430 towards the feeder outlet 410. In other words, the shaft diameter C1 (14 mm) of the screw conveyor 430 at the proximal end is less than the shaft diameter C2 (40 mm) of the screw conveyor 430 at the distal end. Particularly, the shaft diameter C1 decreases along a part of the length L2 (˜75 mm) towards the distal end of the screw conveyor 430 towards the feeder outlet. The shaft diameter C2 of a remaining part L1 of the length L of the screw conveyor 430 is constant.

A flight outside diameter A of the screw conveyor 430 is constant, for example substantially constant, along the length L of the screw conveyor 430 towards the feeder outlet 410.

A pitch P of the screw conveyor 430 increases along the length L of the screw conveyor 430 towards feeder outlet 410. In other words, the pitch P1 (48 mm) of the screw conveyor 430 at the proximal end is greater than the pitch P2 (36 mm) of the screw conveyor 430 at the distal end. The pitch P of the screw conveyor 430 increases along the part of the length L2 (˜75 mm) of the screw conveyor 430 towards the feeder outlet, for example the part towards the distal end. The pitch P2 of the screw conveyor 430 of the remaining part L1 of the length L of the screw conveyor 430 is constant.

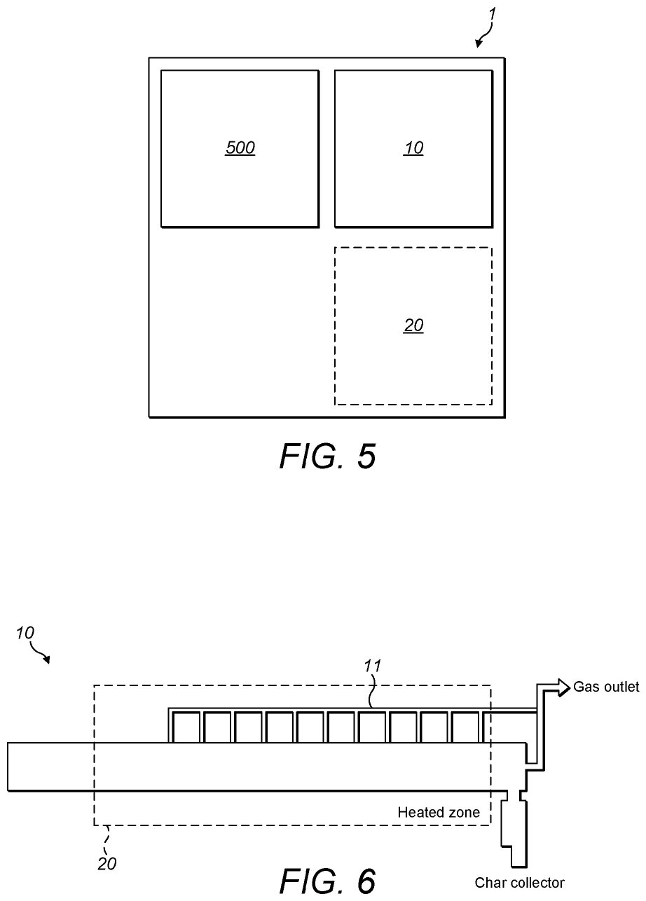

FIG. 5 schematically depicts an apparatus 1000 according to an exemplary embodiment.

The apparatus 1 is for thermolysing a textile. The apparatus 1000 comprises a feeder 500 and a thermal reactor 10. Optionally, the apparatus may comprise a collector 20.

FIG. 6 schematically depicts the thermal reactor 10 of the apparatus 1 of FIG. 5, in more detail. Particularly, the thermal reactor includes twelve (i.e. a plurality of) gas outlets 11. The plurality of gas outlets 11 aid removal of gases formed during the thermolysing. This arrangement of the plurality of gas outlets 11 may reduce problems with gas flow into the thermal reactor 10. Additionally and/or alternatively, this arrangement of the plurality of gas outlets 11 may reduce secondary reactions due to a long residence of the gases in the thermal reactor 10.

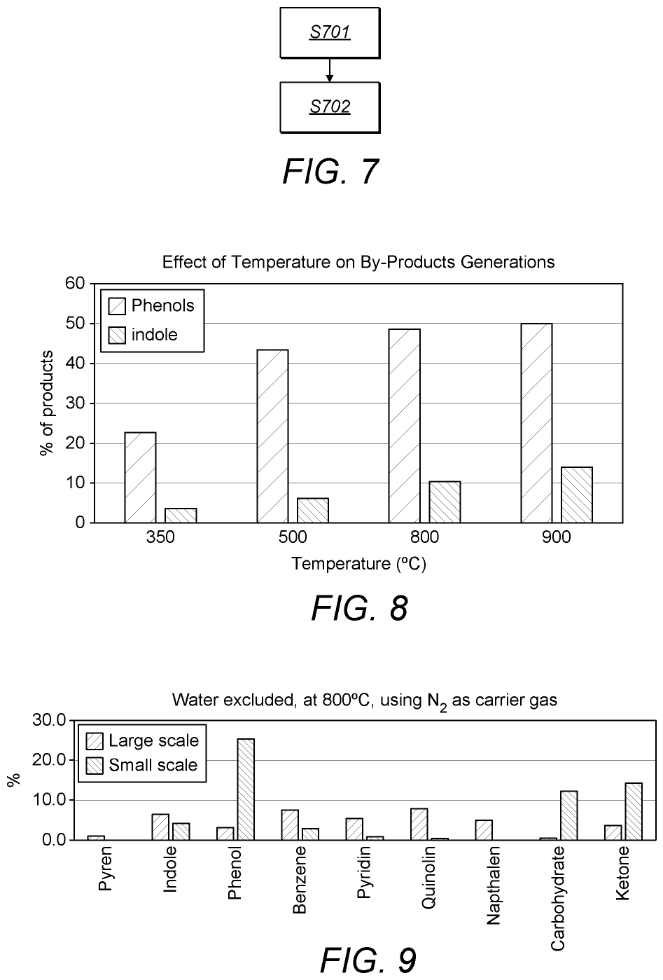

FIG. 7 schematically depicts a method according to an exemplary embodiment. The method is of providing a thermolysis oil comprising an N-heterocyclic aromatic compound, a phenol and/or a substituted derivative thereof.

At S701, a textile comprising keratin is thermolysed, to provide vapours from the textile.

At S702, the vapours are condensed to obtain the oil.

The method may comprise any of the steps described herein.

FIG. 8 schematically depicts a graph showing thermolysis liquid product composition as a function of temperature.

FIG. 9 schematically depicts a graph showing thermolysis liquid product composition at 800° C. using different reactor sizes in presence of N₂ as carrier gas.

Bench scale pyrolysis and gasification of textile wool were performed using a customised semi-fixed bed reactor, under conditions as shown in Table 6.

TABLE 6
Pyrolysis and gasification conditions, where loose indicates
woollen spinning waste cut or shredded at 1.5 cm.

| Run | 1 | 2 | 3 | 4 | 5 | 6 | 7 | 8 |
|---|---|---|---|---|---|---|---|---|
| Temperature/ | 700 | 800 | 900 | 800 | 800 | 800 | 350 | 500 |
| ° C. | | | | | | | | |
| Injected gas | CO₂ | CO₂ | CO₂ | CO₂ | N₂ | N₂ | CO₂ | CO₂ |
| Textile size | 1 cm × | 1 cm × | 1 cm × | Loose | 1 cm × | Loose | Loose | Loose |
| | 4 cm | 4 cm | 4 cm | | 4 cm | | | |

Bio oil was collected from each run, using a first collector immersed in ice/water bath and a second collector immersed in liquid nitrogen (small reactor), while only an ice/water bath was used in the tests using the large reactor. GC-MS was used to identify chemical components of the bio oils, as described below. The bio oils mainly comprise phenols, nitriles and indoles (i.e. an N-heterocyclic aromatic compound and/or a substituted derivative thereof), as summarised in Table 7.

TABLE 7
GC-MS results for bio oils.

| | | Thermolysing | |
|---|---|---|---|
| Component | Amount/wt. % | temperature/° C. | Comment |
| 5,10-Diethoxy- | ~6 | 350 | Potential |
| 2,3,7,8-tetrahydro- | | | antimicotic. |
| 1H,6H-Dipyrrolo[1,2- | | | |
| a:1′,2′-d]pyrazine | | | |
| para-Cresol (4- | 8-32 | 350-900 | |
| methylphenol) | | | |
| Phenols | 3-30 | 350-900 | |
| Indoles | 3-10 | 350-900 | |
| Quinolines | 3-15 | >500 | |
| Piperidinones | 3-18 | >500 | |
| 2,4- | 7-15 | >800 | |
| Imidazolidinedione, | | | |
| 5,5-dimethyl- | | | |
| 2-Pentanone, 4- | 2-6 | 350-900 | |
| hydroxy-4-methyl- | | | |

The chemical compositions of the bio oil samples were analysed using Gas Chromatography Mass Spectrometry, Fisons GC 8000 series equipped with VG Trio 1000. The column (length: 30 m, inner diameter: 0.250 mm; film: 0.25 μm) had temperature limits between 40° C. to 300° C. The oven was programmed to hold at 40° C. for 10 min, ramp at 5° C./min to 200° C. and hold for 15 min, ramp at 10° C./min to 240° C. and hold for 15 min, ramp at 10° C./min to 260° C. and hold for 10 min. He was used as carrier gas with constant flow rate of 1.7 ml/min and injector split ratio at 1:20 ratio. The end of the column was directly introduced into the ion source detector of VG Trio 1000 series. Typical mass spectrometer operating conditions were as follows: transfer line 270° C., ion source 250° C., electron energy of 70 eV. The chromatographic peaks were identified according to the NIST library to identify bio oil components.

Textile size did not significantly affect bio oil composition. In other words, based on runs 2 and 4 at 800° C. with the CO₂ gas, the only difference between the oil obtained from whole wool and shredded textile wool was a type of phenol obtained. In more detail, Phenol, 2-methyl was a dominant product for run 2 while Phenol, 3-methyl- was a dominant product in run 4.

The effect of temperature was significant in obtaining several valuable chemical components. For example, the production of the phenols and indoles, which were obtained in every run, was observed to be dependent on temperature. As shown in FIG. 8, the production of both phenols and indoles increases significantly as the thermolysis temperature increase from 350° C. to 500° C.; almost doubling for both indoles and phenols. However, the increase for phenols is dramatically less when the temperature is increased by 300° C. to 800° C. Furthermore, the increase is insignificant when the temperature is increased by another 100° C. The high percentage of phenols is a promising since phenols may have a market value of £38/litre if high purities may be obtained. Similarly, indoles and quinolines may be marketed at values as high as £50/kg and £80/kg, respectively.

That is, these bio oils are thermolysis oils derived from textile, the oils comprising an N-heterocyclic aromatic compound and/or a substituted derivative thereof in an amount of at least 2 wt. %

Since two different feed cuts were used (1 cm×4 cm and 1 cm×1.5 cm), their importance in the final product distribution could be observed. As expected, due to the similarity in the chemical composition of the feed, the product distribution was not effected significantly by the change in the feed type. The main difference was that different isomers of Cresol (a phenolic compound) were obtained in different quantities when the wool type was switched.

The effect of the injected gas on the product was evaluated. Similar to effect of the wool type, one of the observations was the change in phenol isomer collected (P-cresol for N₂, M-cresol for CO₂).

Although a preferred embodiment has been shown and described, it will be appreciated by those skilled in the art that various changes and modifications might be made without departing from the scope of the invention, as defined in the appended claims and as described above.

In summary, the invention provides a thermolysis oil derived from textile, a method of providing a thermolysis oil, a feeder for an apparatus for thermolysing a textile, an apparatus for thermolysing a textile and a use of waste textile.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A thermolysis oil derived from textile, the oil comprising an N-heterocyclic aromatic compound and/or a substituted derivative thereof in an amount of at least 2 wt. %.

2. The oil of claim 1, comprising phenol and/or a substituted derivative thereof in an amount of at least 10 wt. %.

3. The oil according to claim 1, wherein the N-heterocyclic aromatic compound is pyrrole, pyridine, imidazole, pyrimidine, purine, piperidinone, pyrazine, indole, quinoline or a mixture thereof, preferably indole, quinoline, pyrrole, piperidinone, pirazine or a mixture thereof, more preferably indole and quinoline.

4. A method of providing a thermolysis oil comprising an N-heterocyclic aromatic compound, a phenol and/or a substituted derivative thereof, the method comprising: thermolysing a textile comprising keratin, to provide vapours from the textile; condensing the vapours to obtain the oil.

5. The method according to claim 4, wherein the textile comprises keratin, preferably α-keratin, in an amount of at least 20 wt. %.

6. The method according to claim 5, wherein the textile comprises wool in an amount of at least 30 wt. %, at least 40 wt. % or at least 50 wt. %,_the wool comprising at least a part of the keratin.

7. The method according to claim 4, wherein the thermolysing comprises pyrolysing at a temperature of from about 350° C. to about 900° C., preferably from about 400° C. to about 750° C., more preferably from about 475° C. to about 600° C.; and/or wherein the thermolysing comprises gasification at temperature of from about 750° C. to about 1000° C., preferably from about 800° C. to about 900° C.

8. The method according to claim 7, wherein the thermolysing comprises thermolysing at a N₂ pressure of from about 0.1 to about 1 MPa and/or at a CO₂ partial pressure of from about 0.05 to about 0.2 MPa and/or wherein the thermolysing comprises pyrolysing at an O₂ partial pressure of at least 0.025 MPa and/or wherein the thermolysing comprises gasification at an O₂ equivalent ratio (ER) of from about 0.2 to about 0.35, more preferably about 0.25.

9. The method according to claim 4, the method comprising shredding the textile and thermolysing the shredded textile, optionally wherein at least 50% of the shredded textile by weight has a size of at most 1.5 cm.

10. The method according to claim 4, the method comprising separating the N-heterocyclic aromatic compound, the phenol and/or the substituted derivative thereof from the oil.

11. The method according to claim 4, wherein the textile comprises waste textile, optionally in an amount of at least 10 wt. %.

12. A feeder for feeding textile into a thermal reactor for thermolysing the textile; wherein the feeder comprises a hopper arranged to receive the textile, a feeder outlet coupleable to the thermal reactor and a screw conveyor arranged therebetween, wherein the screw conveyor is arranged to, in use, urge at least a part of the textile from the hopper towards the feeder outlet; and wherein the feeder further comprises a loosening means arranged between the hopper and the screw conveyor, wherein the loosening means is arranged to, in use, loosen at least the part of the textile and thereby urge at least the part of the textile from the hopper towards the screw conveyor.

13. The feeder according to claim 12, wherein the loosening means comprises a rotatable arm, arranged to rotate in use, preferably a plurality of rotatable arms, arranged to rotate in use and optionally, wherein the plurality of rotatable arms are mutually rotatationally offset.

14. The feeder according to claim 13, wherein a rotational axis of the rotatable arm is aligned with and/or parallel to a rotational axis of the screw conveyor.

15. The feeder according to claim 12, wherein the screw conveyor is arranged to extend through the feeder outlet.

16. The feeder according to claim 12, wherein a shaft diameter of the screw conveyor decreases along a length of the screw conveyor towards the feeder outlet.

17. The feeder according to claim 12, wherein a flight outside diameter of the screw conveyor is constant along a length of the screw conveyor towards the feeder outlet.

18. The feeder according to claim 12, wherein a pitch of the screw conveyor increases along a length of the screw conveyor towards feeder outlet.

19. An apparatus for thermolysing a textile, the apparatus comprising a feeder according to claim 12 and a thermal reactor.

20. The apparatus according to claim 19, wherein the thermal reactor is a screw reactor and wherein the screw conveyor of the feeder is coupled to a screw conveyor of the screw reactor, optionally wherein the screw conveyor of the feeder and the screw conveyor of the screw reactor are integrally formed.

21. (canceled)

22. (canceled)
